(19) United States
(12) Patent Application Publication
(10) Pub. No.: US 2005/0129914 A1
(43) Pub. Date: Jun. 16, 2005

(54) Protective fabrics

(76) Inventors: Peter B. Rim, Midlothian, VA (US); Ronald P. Rohrbach, Flemington, NJ (US); Peter D. Unger, Convent Station, NJ (US); Daniel E. Bause, Flanders, NJ (US)

Correspondence Address: Richard S. Roberts;Roberts & Mercanti, L.L.P., P.O. Box 484, Princeton, NJ, 08542-0484, US

(21) Appl. No.: 10/718,467

(22) Filed: Nov. 20, 2003

(51) Int. Cl. B32B 31/00; B32B 23/02

(52) U.S. Cl. 428/192; 428/193; 428/194; 428/397; 428/398; 428/372; 442/334; 442/335; 442/337; 442/339; 156/290

(57) ABSTRACT

A composite textile article for garments which are useful as a barrier for chemical and biological contaminants, such as nerve gas and infectious microorganisms from a surrounding atmosphere. The composite textile article has a sheet of a water vapor permeable central textile fabric composed of polymeric multilobal fibers, having a central core and T-shaped lobes projecting therefrom, and which sheet of central textile fabric has been impregnated with at least one biological and/or chemical decontamination reagent in an amount sufficient to chemically modify, neutralize and/or decontaminate chemical and/or biological contaminants. A pair of sheets of outer textile fabrics, are positioned on the front and rear sides of the central textile fabric. The sheet of central textile fabric and the pair of sheets of outer textile fabrics are attached together via a sealed hem around their perimeter such that it prevents the at least one biological and/or chemical decontamination reagent from passing through the hem.

### BACKGROUND OF THE INVENTION

1. Field of the Invention

The present invention relates to protective fabrics. More particularly, the invention relates to fabrics for garments which are useful as a barrier for chemical and biological contaminants, such as nerve gas and infectious microorganisms from a surrounding atmosphere.

2. Description of the Related Art

The threat of biological and chemical warfare has grown considerably in recent years. Highly dangerous biological and chemical warfare agents have been developed and stockpiled by several nations. Some of these potent biological agents include bacteria such as Bacillus anthracis (anthrax) and Yersinia pestis (plague); viruses such as variola virus (small pox) and flaviviruses (hemmorhagic fevers); and toxins such as botulinum toxins and saxitoxin. Examples of some potent chemical agents include blister or vesicant agents such as mustard agents; nerve agents such as methylphosphonothioc acid (VX); lung damaging or choking agents such as phosgene (CG); cyanogen agents such as hydrogen cyanide; incapacitants such as 3-quinuclidinyl benzilate; riot control agents such as orthochlorobenzylidene malononitrile (CS); smokes such as zinc chloride smokes; and some herbicides such as 2,4-D (2-4-dichlorophenoxyacetic acid).

Such biological and chemical warfare agents pose a significant risk to private citizens as well as to military personnel. For example, nerve agents are particularly toxic and are generally colorless, odorless, and readily absorbable through the lungs, eyes, skin, and intestinal tract. Even a brief exposure can be fatal and death can occur as quickly as 1 to 10 minutes. Vesicant agents are known to burn and blister the skin or any other part of the body they contact, including eyes, mucus membranes, lungs, and skin. Biological agents such as anthrax are easily disseminated as aerosols and thus have the ability to inflict a large number of casualties over a wide area.

Known techniques for protecting humans from breathing-in hazardous chemical and biological substances include full-body protective suits in conjunction with respiratory masks or gas masks. Typically, such masks include a respiratory cup which fits over the user's mouth and nose, and is secured to the user's head. Such respiratory cups typically include a connection to an oxygen source, and a filter element containing a decontamination media for removing harmful substances from the air breathed in by the user.

However, this suffers from several disadvantages. The usefulness of a respiratory mask is dependent on the lifespan and efficiency of its filter element. Conventional decontamination filters are only useful for relatively short periods of time, i.e. 30 minutes or less, because there is a limit to the amount of decontamination media which they can hold. Thus, conventional decontamination filters are relatively inefficient, and frequently result in a relatively high pressure differential across the filter and the decontamination media of the filter.

Chemical-biological protective suits are designed to provide a completely impermeable barrier to any external contaminants from entering the inner zone. However, both heat and moisture buildup limit the time an individual can remain comfortably within one, due to extreme heat build up. It would be desirable to provide a more efficient, higher capacity absorptive fabric for the neutralization and/or decontamination of chemical and/or biological contaminants for such protective suits.

According to the present invention, a composite textile article is provided from which chemical-biological protective suits can be manufactured. The invention provides a multi-component layered construction having a strong supportive backing, a biological and/or chemical protective layer, and a water impermeable layer. All of these materials have an open fibrous structure to both accommodate air and water vapor flow. The composite textile article includes a central sheet of a textile fabric made from polymeric multilobal fibers. These fibers include a central core having a plurality of T-shaped lobes projecting therefrom, with each T-shaped lobe having a leg and a cap. The lobes define a longitudinally extending internal cavity between two adjacent legs that extends the entire length of the fiber. The fibers are impregnated with a biological and/or chemical decontamination reagent in an amount sufficient to chemically modify, neutralize, decontaminate, absorb, and/or adsorb airborne biological and/or chemical contaminants from a breathable atmosphere. The structure of the polymeric multilobal fibers allows the fibers to hold the decontamination reagent. The central textile fabric is surrounded by a pair of sheets of water vapor permeable outer textile fabrics. The three layers are sealed together at a hem such that it prevents the decontamination reagent from passing through the hem.

### SUMMARY OF THE INVENTION

The invention provides a composite textile article which comprises:
a) a sheet of a central textile fabric having a front side and a rear side; said sheet of central textile fabric being water vapor permeable, and which sheet of central textile fabric comprises a plurality of fibers having semi-opened micro-cavities; and which fibers have been impregnated with at least one biological and/or chemical decontamination reagent in an amount sufficient to chemically modify, neutralize and/or decontaminate chemical and/or biological contaminants;
b) a pair of sheets of outer textile fabrics, one of the sheets of outer textile fabrics positioned on the front side of the sheet of central textile fabric and the other sheet of outer textile fabric positioned on the rear side of the sheet of central textile fabric; each sheet of outer textile fabric being water vapor permeable;
c) the sheet of central textile fabric and the pair of sheets of outer textile fabrics being attached together via a sealed hem around a perimeter of the sheet of central textile fabric and the pair of sheets of outer textile fabrics, which hem is sealed such that it prevents the at least one biological and/or chemical decontamination reagent from passing through the hem.

The invention also provides a method of producing a composite textile article which comprises:
a) providing a sheet of a central textile fabric having a front side and a rear side; said sheet of central textile fabric being water vapor permeable, and which sheet of central textile fabric comprises a plurality of fibers having semi-opened micro-cavities; and which fibers have been impregnated with at least one biological and/or chemical decontamination reagent in an amount sufficient to chemically modify, neutralize and/or decontaminate chemical and/or biological contaminants;
b) providing a pair of sheets of outer textile fabrics, one of the sheets of outer textile fabrics positioned on the front side of the sheet of central textile fabric and the other sheet of outer textile fabric positioned on the rear side of the sheet of central textile fabric; each sheet of outer textile fabric being water vapor permeable;
c) attaching the sheet of central textile fabric and the pair of sheets of outer textile fabrics being attached together via a sealed hem around a perimeter of the sheet of central textile fabric and the pair of sheets of outer textile fabrics, which hem is sealed such that it prevents the at least one biological and/or chemical decontamination reagent from passing through the hem.

### BRIEF DESCRIPTION OF THE DRAWINGS

FIG. 1 shows a non-woven arrangement of a plurality of multilobal fibers.

FIG. 2 shows a non-woven arrangement of a plurality of multilobal fibers having biological and/or chemical decontamination reagent powder particles infused inside the cavities of T-shaped lobes.

FIG. 3 shows a perspective view of a multilobal fiber having three T-shaped lobes with curved caps.

FIG. 4 shows a perspective view of three layered composite textile article which has a sheet of a central textile fabric and a pair of sheets of outer textile fabrics positioned on the front and rear of the sheet of central textile fabric.

FIG. 5 shows a perspective view of three layered composite textile article showing the central textile fabric and a pair of sheets of outer textile fabrics sealed at a hem and also showing strips of hook and loop fastener.

FIG. 6. shows a protective garment composed of the composite textile article.

### DETAILED DESCRIPTION OF THE PREFERRED EMBODIMENT

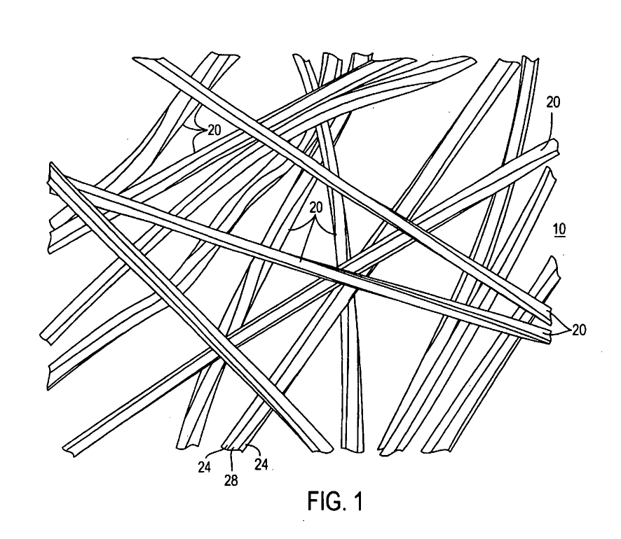

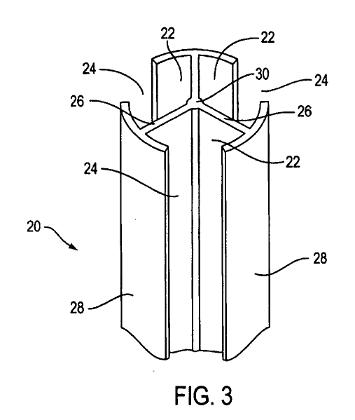

The invention relates to a composite textile article for removing airborne biological and/or chemical contaminants from a breathable atmosphere. According to the invention, a sheet of a central textile fabric is produced from plurality of fibers having semi-opened micro-cavities, and preferably a plurality of polymeric multilobal fibers. The fibers of this invention preferably comprise trilobal fibers. Such fibers are shown in FIGS. 1-3. FIG. 3 shows a trilobal fiber 20, commercially available from Honeywell International Inc. as TRIAD® fiber, having three T-shaped lobes projecting from a central fiber core 30. Multilobal fibers having this structure are described in U.S. Pat. Nos. 5,057,368 and 5,744,236 which are incorporated herein by reference. As seen in FIG. 3, each of the T-shaped lobes comprises a leg 26 and a cap 28. These caps 28 may be curved, as seen in FIG. 3, or they may be straight. Other known multilobal fibers are quadrilobal, hexalobal, pentalobal, tetralobal, and octalobal filament fibers, and are described in U.S. Pat. No. 5,069,970 which is incorporated herein by reference. However, these are less preferred for the purposes of this invention because they limit the amount of space available for infusion of biological and/or chemical decontamination reagent powder particles that are incorporated as part of the invention.

Between two adjacent lobes is formed a cavity 22 and extending from each cavity 22 is a long longitudinal opening 24 that extends along the entire length of the fiber 20. The angle of separation between adjacent legs 26 may vary widely and depends on the number of lobes. Preferably, the legs 26 are separated from each other by an angle of from about 80° to about 130°. In the three lobed embodiment of FIG. 3, the angle of separation of legs 26 is from about 110° to about 130°, more preferably from about 115° to about 125°, and most preferably by about 120°.

The length and width of the legs 26 and caps 28 of the T-shaped lobes may vary widely. In general, the length of each leg 26 is selected such that the caps 28 of adjacent T-shaped lobes do not contact each other to form an enclosed tube like structure. Otherwise, only a minimal amount of the decontamination agent would make it into the cavities 22. Usually, the length of each leg 26 is from about 4.5 to about 890 μm and the width of leg 26 is from about 0.5 to about 90 μm. In the preferred embodiments of the invention, the average length of each leg 26 is from about 4.5 to about 100 μm, more preferably from about 4.5 to about 50 μm, and most preferably from about 4.5 to about 25 μm. Preferably the average width of each leg 26 is from about 0.5 to about 80 μm, more preferably from about 0.5 to about 60 μm, and most preferably from about 0.7 to about 40 μm. The length of cap 28 is preferably from about 4.5 μm to about 1600 μm. More preferably, the length of each cap 28 is from about 4.5 μm to about 120 μm, and even more preferably from about 4.5 μm to about 75 μm. The width of each cap 28 is preferably from about 0.5 μm to about 90 μm, more preferably from about 0.5 μm to about 80 μm, and even more preferably the width is from about 0.5 μm to about 60 μm. In the most preferred embodiment of the invention, the length of each cap 28 is from about 4.5 μm to about 50 μm and the width of each cap 28 is from about 0.7 μm to about 40 μm.

The length of cap 28 of any fiber will depend on the length and width of legs 26 of each T-shaped lobe and the width of cap 28. For example, in general, the longer leg 26 of a lobe, the longer the permissible length of cap 28 becomes. Conversely, the shorter the leg 26, the shorter the permissible length of cap 28. The length of leg 26 and cap 28 of adjacent T-shaped lobes are selected such that a T-shaped lobe forms and such that caps 28 of adjacent T-shaped lobes do not intersect. The relationship between the length and width of the legs 26 and the length and width of caps 28 is more adequately described in U.S. Pat. No. 5,057,368 mentioned above.

The polymeric fibers 20 preferably comprise a thermoplastic polymer capable of being spun into a fiber, including polyamides, polyesters and polyolefins and blends thereof. Preferably, the polymer is formed into a polymer melt and then extruded and spun into fibers 20 having the desired shape and form. The fibers 20 may then be arranged into a fabric 10 that may be either woven or non-woven. FIG. 1 illustrates a non-woven fabric 10 of the invention which is formed by fibers 20 which are arranged in random order. Such fabrics may be present in any suitable shape or size. The fabric is then impregnated with at least one biological and/or chemical decontamination reagent. The decontamination reagent serves to chemically modify, neutralize and/or decontaminate chemical and/or biological contaminants in a breathable atmosphere, such as air. The biological and/or chemical decontamination reagent is preferably impregnated in the filter in an amount sufficient to chemically modify, neutralize and/or decontaminate chemical and/or biological contaminants in the breathable atmosphere which is passed through the filter. The biological and/or chemical decontamination reagent may be impregnated into the fabric form of a solid, liquid, gas, vapor, or any other phase, and in combinations thereof. In one preferred embodiment, the biological and/or chemical decontamination reagent is impregnated into the filter fibers in the form of a liquid. In a preferred embodiment, the biological and/or chemical decontamination reagent is impregnated into the filter fibers in the form of particles such as powder particles.

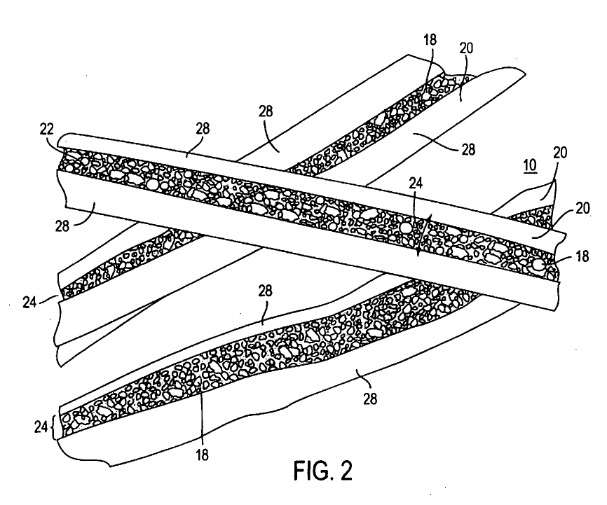

As shown in FIG. 2, biological and/or chemical decontamination reagent powder particles 18 are infused both between said arranged fibers 20 and within cavities 22 of the fibers. This is preferably done without the use of adhesives. The biological and/or chemical decontamination reagent powder particles 18 are preferably present at a suitable size, shape and makeup that they may be securely retained within the cavities 22. Such decontamination reagent powder particles preferably range in size from about 1 nanometer to about 100 micrometers in diameter, more preferably from about 0.1 micrometer to about 50 micrometers in diameter, and most preferably from about 1 micrometer to about 10 micrometers in diameter. The reagent powder particles may first be impregnated into the cavities of the fibers and then the fibers formed into a fabric, or the fibers may first be formed into a fabric and then the reagent powder particles impregnated into the cavities of the fibers. In another embodiment, in addition to the fibers being impregnated with the reagent powder particles, the fabric is also impregnated with reagent powder particles, i.e. between the fibers.

Examples of suitable biological and/or chemical decontamination reagents nonexclusively include adsorbents such as activated carbon, zeolites, agar/agarose hydrogel imbibed with alkali such as sodium hydroxide, potassium hydroxide, and ammonium hydroxide; acids; bases such as ammonia compounds, sodium phosphate; deliquescing agents such as lithium chloride, polymethioine, cyanogen bromide, immobilized acetylcholinesterase; organometallic catalysts such as copper/cobalt; enzymes with regenerable cofactors such as nucleophilic oximes and butyrylcholinestrerase. Other suitable decontamination reagents nonexclusively include cyanide carbonyls, carbonimides, substituted phosphoric acid, esters, thioethers, nitrogen heterocycles, olefinics, oxidizing agents such as peroxides, peracetates, perborates, sodium permanganate, potassium permanganate, calcium hypochlorite, calcium oxide, detergents and surfactants, quaternary ammonium complexes such as benzyltrimethyl ammonium chloride and ethyl ammonium chloride, zinc chloride, iron sulfate, sulfuric acid, phosphoric acid, and titanium dioxide, and photoreactive reagents or photochemical agents or such as anatase titanium dioxide. The decontamination reagent may comprise one or more suitable solvents as determined by those skilled in the art, such as water, alcohols, phenol, ethanol, diethylenetriamine, and ethylene glycol monomethyl ether.

In another embodiment, the biological and/or chemical decontamination reagent comprises a photochemical agent or photoreactive reagent which is impregnated into the fabric. According to this embodiment, a reaction is initiated by illumination with a light source, causing a photochemical reaction which yields products that are lethal to microorganisms, and/or capable of reacting with and deactivating chemical agents.

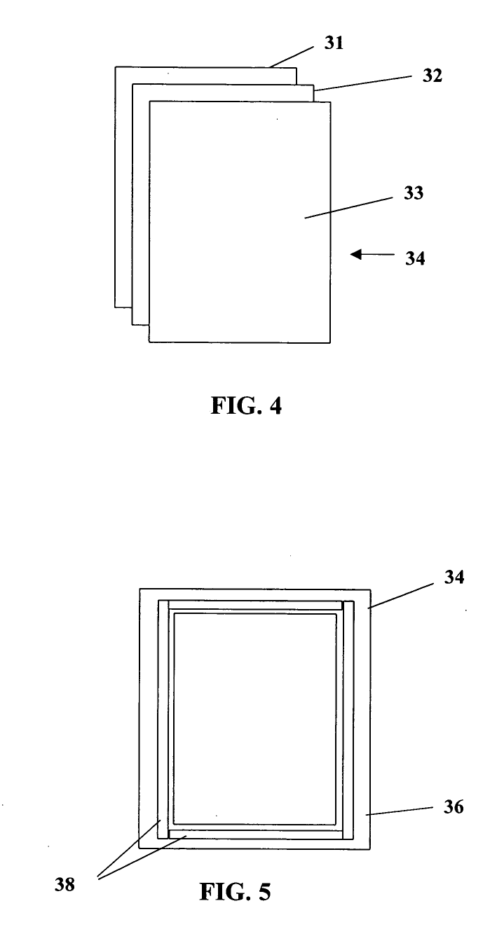

The fabric 20 impregnated with the biological and/or chemical decontamination reagent is then formed into a sheet of a central textile fabric having a front side and a rear side which is water vapor permeable and either liquid permeable or liquid impermeable depending on the spacing between fibers. The sheet is then positioned between a pair of sheets of outer textile fabrics, one of the sheets of outer textile fabrics is positioned on the front side of the sheet of central textile fabric and the other sheet of outer textile fabric positioned on the rear side of the sheet of central textile fabric. Each sheet of outer textile fabric is water vapor permeable and either liquid permeable or liquid impermeable. FIG. 4 shows a composite textile article 34 having a sheet of a central textile fabric 32 applied on opposite side with sheets of outer textile fabric 31 and 33. Sheets 31 and 33 may be composed of woven or nonwoven fibers of a suitable polymer such a polyester, a polyolefin such as polyethylene, a polyamide or the like. In one embodiment of the invention at least one of the sheets 31 and 33 is a bullet resistant material such as Spectra Shield®, Gold Shield®, or Z Shield® composite materials, commercially available from Honeywell International Inc., or a fabric made from Dupont's Kevlar® or Honeywell's Spectra® fibers. The outer layers may also be composed of a tear-resistant material such as nylon/cotton rip-stop materials. The finished product should also meet military specifications for protective gear set forth in the document MIL-DTL-32102A. It is within the contemplation of the invention that composite textile article has a central textile fabric comprising several individual layers of the central textile fabric material, each with a different biological and/or chemical decontamination reagent. One or both of the sheets of outer textile fabric may also comprise a plurality of the fibers having semi-opened micro-cavities; and which fibers have been impregnated with at least one biological and/or chemical decontamination reagent. In another embodiment, in addition to the fibers of the outer textile fabric being impregnated with the reagent powder particles, the outer textile fabric is also impregnated with reagent powder particles, i.e. between the fibers.

FIG. 5 shows a composite textile article 34 where the central textile fabric 32 is applied on opposite side with sheets of outer textile fabrics 31 and 33 which are attached together via a sealed hem 36 around a perimeter of the sheet of central textile fabric and the pair of sheets of outer textile fabrics. The hem is sealed such that it prevents the at least one biological and/or chemical decontamination reagent from passing through the hem. Sealing may be done, for example by heat sealing or welding. The composite textile article may be used for the production of a garment, such as a full body protective suit in a shape configured to contain all or part of a human body, a head covering such as a hat or hood, a tent or a tarp. The edge of the composite textile article may be provided with a fastener 38 to provide a panel which is removably attachable around its periphery by a hook and burr fastener, such as Velcro®.

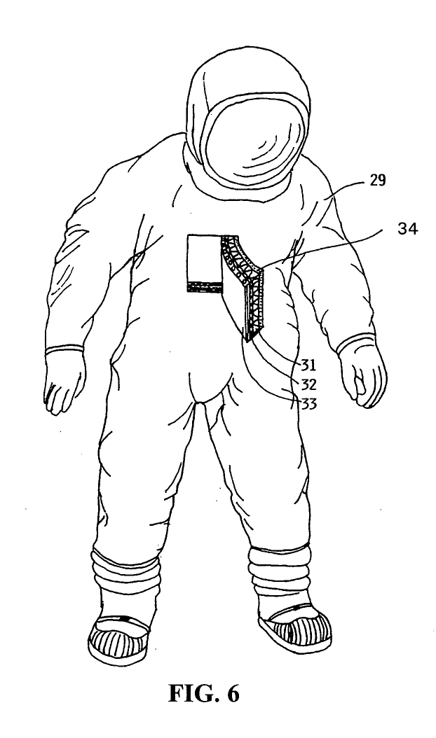

FIG. 6 shows a full body protective suit 29 in a shape configured to contain all or part of a human body using the composite textile article of the invention. The suit is composed of a composite textile article 34 where the central textile fabric 32 is applied on opposite side with sheets of outer textile fabrics 31 and 33. In another embodiment of the invention, the full body protective suit 29 is not fully composed of a composite textile article 34. Rather the suit is composed of a known protective suit material such as a flexible rubberized material which is liquid, gas and vapor impermeable. The garment then has a cutout through the flexible fabric material as seen in FIG. 5. Then a panel of the composite textile article according to the invention is removably attached around a periphery of the cutout by a fastener such as Velcro® Brand. In use, a breathable atmosphere is passed through the composite textile article panel to chemically modify, neutralize and/or decontaminate chemical and/or biological contaminants from the breathable atmosphere. This composite textile article would possess the properties of breathability with respect to air and water vapor, yet at the same time provide protection from chemical and/or biological contaminants.

The following non-limiting example serves to illustrate the invention. It will be appreciated that variations in proportions and alternatives in elements of the components of the invention will be apparent to those skilled in the art and are within the scope of the present invention.

### EXAMPLE 1

A nonwoven fabric is produced comprising a linear array of TRIAD® nylon 6 fibers impregnated with a mixture of a strong oxidizing agent with a surfactant in an alkaline environment as the decontamination reagent. The reagent employed has activity for a broad range of chemical warfare agents. The linear array filter has a configuration, as shown in FIG. 1. A three layer composite is produced comprising an outer sheet of a nonwoven polyethylene to provide the water impermeability, the nonwoven layer of TRIAD® fibers impregnated with the mixture of decontamination reagent, and a woven backing made from Spectra® fiber available from Honeywell International. The three layers are sealed together at a hem such that it prevents the decontamination reagent from passing through the hem.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A composite textile article which comprises:
a) a sheet of a central textile fabric having a front side and a rear side; said sheet of central textile fabric being water vapor permeable, and which sheet of central textile fabric comprises a plurality of fibers having semi-opened micro-cavities; and which fibers have been impregnated with at least one biological and/or chemical decontamination reagent in an amount sufficient to chemically modify, neutralize and/or decontaminate chemical and/or biological contaminants;
b) a pair of sheets of outer textile fabrics, one of the sheets of outer textile fabrics positioned on the front side of the sheet of central textile fabric and the other sheet of outer textile fabric positioned on the rear side of the sheet of central textile fabric; each sheet of outer textile fabric being water vapor permeable;
c) the sheet of central textile fabric and the pair of sheets of outer textile fabrics being attached together via a sealed hem around a perimeter of the sheet of central textile fabric and the pair of sheets of outer textile fabrics, which hem is sealed such that it prevents the at least one biological and/or chemical decontamination reagent from passing through the hem.

2. The composite textile article of claim 1 wherein the fibers comprise polymeric multilobal fibers have a central core having a plurality of T-shaped lobes projecting therefrom, each of said T-shaped lobes having a leg and a cap, said lobes defining a longitudinally extending internal cavity between two adjacent legs that extends the entire length of the fiber.

3. The composite textile article of claim 1 wherein additionally the sheet of central textile fabric has been impregnated between the fibers with at least one biological and/or chemical decontamination reagent.

4. The composite textile article of claim 1 wherein at least one of the sheets of outer textile fabrics comprises a plurality of fibers having semi-opened micro-cavities; and which fibers have been impregnated with at least one biological and/or chemical decontamination reagent.

5. The composite textile article of claim 4 wherein at least one of the sheets of outer textile fabrics has been impregnated between the fibers with at least one biological and/or chemical decontamination reagent.

6. The composite textile article of claim 1 wherein at least one sheet of outer textile fabric is liquid impermeable.

7. The composite textile article of claim 1 wherein at least one sheet of outer textile fabric is liquid permeable.

8. The composite textile article of claim 1 wherein each sheet of outer textile fabric is liquid impermeable.

9. The composite textile article of claim 1 wherein the sheet of central textile fabric is liquid impermeable.

10. The composite textile article of claim 1 wherein each sheet of outer textile fabric is liquid impermeable and the sheet of central textile fabric is liquid impermeable.

11. The composite textile article of claim 1 wherein said central textile fabric has been impregnated with a liquid biological and/or chemical decontamination reagent.

12. The composite textile article of claim 1 wherein said central textile fabric has been impregnated with biological and/or chemical decontamination reagent powder particles.

13. The composite textile article of claim 12 wherein the biological and/or chemical decontamination reagent powder particles have been infused between said fibers and in said cavities, said powder particles being of such a size and shape that they are retained within each cavity.

14. The composite textile article of claim 12 wherein the biological and/or chemical decontamination reagent powder particles range in size from about 1 micron to about 10 microns.

15. The composite textile article of claim 1 wherein the biological and/or chemical decontamination reagent comprises one or more materials selected from the group consisting of acids, bases, adsorbents, activated carbon, zeolites, alumina, silica, deliquescing agents such as lithium chloride, organometallic catalysts, enzymes with regenerable cofactors such as butyrylcholinestrerase, oxidizing agents, detergents, surfactants, quaternary ammonium complexes, photochemical agents, and solvents.

16. The composite textile article of claim 1 wherein the biological and/or chemical decontamination reagent comprises one or more materials selected from the group consisting of sodium hydroxide, potassium hydroxide, ammonium hydroxide; ammonia compounds, sodium phosphate; polymethioine, cyanogen bromide, immobilized acetylcholinesterase on alumina or silica, copper/cobalt, nucleophilic oximes, lithium chloride, butyrylcholinestrerase, cyanide carbonyls, carbonimides, substituted phosphoric acid, esters, thioethers, nitrogen heterocycles, olefinics, peroxides, peracetates, perborates, sodium permanganate, potassium permanganate, calcium hypochlorite, calcium oxide, benzyltrimethyl ammonium chloride, ethyl ammonium chloride, zinc chloride, iron sulfate, sulfuric acid, phosphoric acid, titanium dioxide, water, alcohols, phenol, ethanol, diethylenetriamine, and ethylene glycol monomethyl ether.

17. An garment which comprises the composite textile article of claim 1.

18. A head covering which comprises the composite textile article of claim 1.

19. A garment which comprises a flexible fabric material in a shape configured to contain all or part of a human body; a cutout through the flexible fabric material; and a panel removably attached around a periphery of the cutout; which panel comprises the composite textile article of claim 1.

20. The garment of claim 19 wherein the panel is removably attached around a periphery of the cutout by a hook and burr fastener.

21. A method of producing a composite textile article which comprises:
a) providing a sheet of a central textile fabric having a front side and a rear side; said sheet of central textile fabric being water vapor permeable, and which sheet of central textile fabric comprises a plurality of fibers having semi-opened micro-cavities; and which fibers have been impregnated with at least one biological and/or chemical decontamination reagent in an amount sufficient to chemically modify, neutralize and/or decontaminate chemical and/or biological contaminants;
b) providing a pair of sheets of outer textile fabrics, one of the sheets of outer textile fabrics positioned on the front side of the sheet of central textile fabric and the other sheet of outer textile fabric positioned on the rear side of the sheet of central textile fabric; each sheet of outer textile fabric being water vapor permeable;
c) attaching the sheet of central textile fabric and the pair of sheets of outer textile fabrics being attached together via a sealed hem around a perimeter of the sheet of central textile fabric and the pair of sheets of outer textile fabrics, which hem is sealed such that it prevents the at least one biological and/or chemical decontamination reagent from passing through the hem.

22. The method of claim 21 wherein the fibers comprise polymeric multilobal fibers have a central core having a plurality of T-shaped lobes projecting therefrom, each of said T-shaped lobes having a leg and a cap, said lobes defining a longitudinally extending internal cavity between two adjacent legs that extends the entire length of the fiber.

23. The method of claim 21 wherein additionally the sheet of central textile fabric has been impregnated between the fibers with at least one biological and/or chemical decontamination reagent.

24. The method of claim 21 wherein at least one of the sheets of outer textile fabrics comprises a plurality of fibers having semi-opened micro-cavities; and which fibers have been impregnated with at least one biological and/or chemical decontamination reagent.

25. The composite textile article of claim method of claim 24 wherein at least one of the sheets of outer textile fabrics has been impregnated between the fibers with at least one biological and/or chemical decontamination reagent.

26. The method of claim 21 wherein at least one sheet of outer textile fabric is liquid impermeable.

27. The method of claim 21 wherein at least one sheet of outer textile fabric is liquid permeable.

28. The method of claim 21 wherein each sheet of outer textile fabric is liquid impermeable.

29. The method of claim 21 wherein the sheet of central textile fabric is liquid impermeable.

30. The method of claim 21 wherein each sheet of outer textile fabric is liquid impermeable and the sheet of central textile fabric is liquid impermeable.

31. A method which comprises providing the composite textile article of claim 1 and then forming the composite textile article into a garment in a shape configured to contain all or part of a human body.

32. A method which comprises providing a garment in a shape configured to contain all or part of a human body, which garment comprises composite textile article of claim 1, and then passing a breathable atmosphere through the composite textile article to thereby chemically modify, neutralize and/or decontaminate chemical and/or biological contaminants from the breathable atmosphere.

33. A method which comprises providing a garment comprising a flexible fabric in a shape configured to contain all or part of a human body, and having a cutout through the flexible fabric material; providing a panel which comprises the composite textile article of claim 1 and removably attaching the panel around a periphery of the cutout.

34. The method of claim 33 wherein the panel is removably attached around a periphery of the cutout by a hook and burr fastener.
